(19) United States
(12) Patent Application Publication
(10) Pub. No.: US 2010/0107845 A1
(43) Pub. Date: May 6, 2010

(54) Arbor mount with punch out center for use with a variety of arbor shapes - five side square shape

(76) Inventor: Kevin Baron, Oxnard, CA (US)

Correspondence Address: SANDRA LEE LIPKIN A LAW CORPORATION, P.O.Box 3518, VENTURA, CA, 93006, US

(21) Appl. No.: 12/290,945

(22) Filed: Nov. 4, 2008

(51) Int. Cl. B26D 7/26; B23D 61/02

(52) U.S. Cl. 83/676; 83/698.41; 83/701

(57) ABSTRACT

A cutting disc core for a circular shaped saw blade which has a circular shaped body which has a center hole and a circular peripheral edge upon which is to be mounted a plurality of spaced apart cutting segments that is to perform the cutting of the saw blade. Surrounding the center hole and formed within the body of the blade is a cut out of a five-sided shape that can be described as a square with rounded corners and with one corner sliced at an angle to leave a fifth side with sharply defined edges. On one or more sides of the five-sided shaped cut out is found one or more pair of radially extending members that together form a break in the continuous shape of the five sided “square” with there being a solid tab that is integrally connected to the body located between each pair of radially extending members. The tab constitutes a frangible seal with the five-sided shape which is formed about the center hole to be removable by being forcibly physically separated from the body.

### BACKGROUND OF THE INVENTION

1. Field of the Invention

The field of this invention relates to a cutting disc core that is to be utilized in forming of a rotary cutting blade with the core being constructed to have a specialized shape arbor mount that can accommodate not only the standard 1 inch or 20 mm diameter arbors, but that can be punched out to accommodate proprietary arbors of unique shape.

2. Description of the Prior Art

There are many different types of cutting machines that utilize circular saw blades. Circular saw blades are typically round blades having cutting teeth along the periphery of the blade. Traditionally, an arbor mounting hole is disposed in the center of the blade. The arbor mounting hole passes over a rotating drive arbor of the cutting machine, thereby interconnecting the drive arbor of the cutting machine to the circular saw blade. The interconnection of the blade arbor mounting hole with the drive arbor of the cutting machine serves two purposes. First, the interconnection of the drive arbor with the blade arbor mounting hole centers the blade so that the blade is balanced when it spins. Second, the interconnection of the drive arbor with the blade arbor mounting hole helps the drive arbor to turn the blade.

The most common type of arbor mounting hole, used on a circular blade saw, is a round hole that is located in the geometric center of the circular saw blade. Such arbor mounting holes pass over round cutting machine arbors that have a diameter close to that of the arbor mounting hole. In such round arbor mounting hole blades, any blade that has a round arbor mounting hole of the proper diameter can be mounted on the cutting machine.

In certain applications, non-circular arbors are used on cutting machines to provide a more positive connection between a circular saw blade and the rotating arbor. By using non-round arbor mounting holes in the blades, the blades are prevented from rotating around the arbor, should the saw blade bind on the material it is cutting. Such non-round arbor mounting holes are typically symmetrically disposed around the geometric center of the circular saw blade. Some examples of non-round arbor mounting holes include shapes such as square-shaped, diamond-shaped and triangular-shaped.

In the wide cross-section of industry that produces cutting machines, some companies have developed cutting machines with asymmetrical drive arbors that are proprietary to the manufacturer. Such asymmetrical drive arbors only accept circular saw blades having arbor mounting holes that are specifically manufactured for that cutting machine. Accordingly, a customer must purchase specialized blades from a specific manufacturer by that manufacturer. In some instances, the arbor mounting hole on such blades is an asymmetric triangle. Other blades have arbor mounting holes that are combinations of straight sides and curved sides.

As is often the case, contractors and manufacturers who utilize cutting machines have different brands of cutting machines that were purchased at different times. A manufacturer would like to have the ability to exchange blades between the different cutting machines in order to reduce blade inventory and save money. However, if the cutting machines require specialized blades, a contractor or manufacturer has no choice but to purchase specialized blades for each of the cutting machines.

A need therefore exists for a new circular saw blade, having an arbor mount that can be attached to different types of cutting machine arbors, even though some arbors may be symmetrical and others asymmetric. This will enable a manufacturer or contractor to purchase one set of blades that can be used on a variety of different cutting machines.

### SUMMARY OF THE INVENTION

The preferred embodiment of the present invention teaches a cutting disc core for a circular saw blade comprising: a circular shaped body having a center hole of a certain size and a continuous peripheral edge, the peripheral edge adapted to having cutting segments mounted thereon; a lasered shape that surrounds the center hole, the lasered shape further comprising a first side; a second side connected substantially perpendicularly to the first side; a third side connected substantially perpendicularly to the second side; a fourth side connected to the third side at an angle greater than 90 degrees; a fifth side connected to the fourth side at an angle greater than 90 degrees and connected substantially perpendicularly to the first side; one or more pairs of radially extending members that extend radially from one of the sides of the lasered shape wherein in combination the one or more pairs of radially extending members defines a tab that can be punched out with force thereby allowing the center of the disc core to no longer define a center hole, but rather to define an empty space of the same shape as the lasered shape for use with arbors of unique shape.

The above embodiment can be further modified by defining that the junction of the first side and the second side is a rounded corner.

The above embodiment can be further modified by defining that the junction of the second side and the third side is a rounded corner.

The above embodiment can be further modified by defining that the junction of the third side and the fourth side is a sharp corner.

The above embodiment can be further modified by defining the junction of said fourth side and said fifth side is a sharp corner.

The above embodiment can be further modified by defining that the junction of said fifth side and said first side is a rounded corner.

### BRIEF DESCRIPTION OF THE DRAWINGS

FIG. 1 is a front view of the cutting disc core of the instant invention with the standard center hole and the etched five-sided “square” shape of the cut out still intact as part of the core.

FIG. 2 is a close-up view of the standard center hole with the etched five-sided “square” shape of the cut out still intact as part of the core.

FIG. 3 is taken along the line 3-3 in FIG. 2.

FIG. 4. Is a close-up view of the illustration shown in FIG. 3, but after the frangible connection has been broken.

FIG. 5 is a front view of the cutting disc core of the instant with the etched five-sided “square” shape having been punched out and the frangible seals broken.

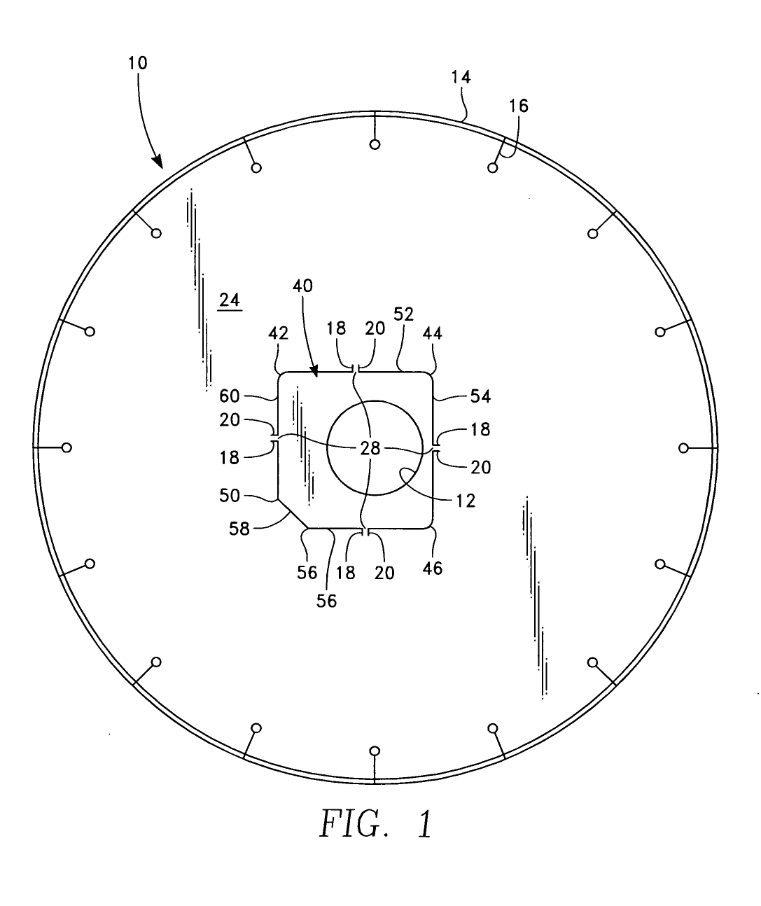

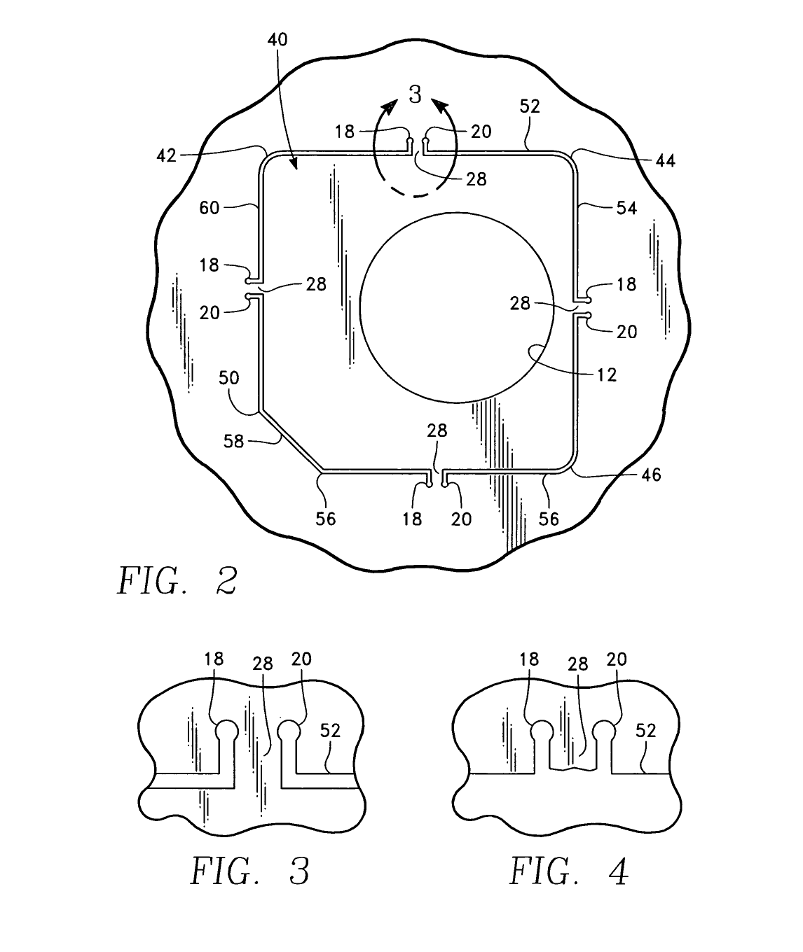

### DETAILED DESCRIPTION OF A PREFERRED EMBODIMENT

Turning to the drawings, the preferred embodiment is illustrated and described by reference characters that denote similar elements throughout the several views of the instant invention.

The present invention describes a circular saw blade 10 with an arbor mount that is pre-cut to a standard 1 inch or 20 mm diameter for fitting on the vast majority of arbor mounts. However, surrounding the center hole 12 and formed within the body 24 of the blade is a cut out of a shape that can be described as a “square” 40 with five sides 52, 54, 56, 58, 60 and with three rounded corners 42, 44, 46 and with one would-be corner 58 sliced at an angle to leave a fifth side 58 with sharply defined edges 50, 56. On one or more sides 52, 54, 56, 58, 60 of the cut out 40 is found one or more pair of radially extending members 18, 20 that break the continuous shape of the cutout 40 and creating tabs 28 that can be broken to punch the cutout shape 40 from the center 12. The tabs 28 constitutes a frangible seal with the blade body 24 which is formed about the center hole 12 to be removable by being forcibly physically separated from the body 24.

The manufacturing benefit of the instant invention goes to the core manufacturer and the blade manufacturer. The three tab knockout arbor will make all manufacturing faster and cheaper. No special tooling and fixtures will be needed as all manufacturers will be able to use their standard tooling. Quality will be greatly improved and much easier to inspect when using standard round arbors.

Referring particularly to the drawings, there is shown the cutting disc core 10 of this invention. The cutting disc core 10 takes the form of a circular shaped body which has an inner center hole 12. The inner center hole 12 is to be used to mount the core 10 onto a sawing machine to affect the rotation of the core 10. The sawing machine is not shown and is deemed to be conventional. The core 10 has a peripheral edge 14. Formed within the peripheral edge 14 are a plurality of radial slots 16. The number of the slots 16 can be increased or decreased depending on the diameter of the core 10. The use of the radial slots 16 is deemed to be conventional and forms no specific part of this invention.

The portion of the peripheral edge 14 located between each directly adjacent pair of radial slots 16 is to define an area to which is to be laser welded a cutting segment (not shown). The mounting of the cutting segments on the core 10 is what produces the cutting blade. Surrounding the inner center hole 12 is a lasered cut out 40 with the five-sided “square” shape defined above. This “square” to be formed from some type of cutting device, such as a laser. The “square” is to be formed entirely through the body 24 of the core 10.

On one or more of the sides 52, 54, 56, 58 60 of the “square” can be placed at least one pair of radially extending members 18, 20 that effectively cut off the continuous perimeter of the “square.” Separating the radially extending members 18, 20 is effectively formed a tab 28. It is to be understood that any number of tabs 28 can be added to the periphery of the “square,” 40, which is shown as four in the attached drawings, but it can be as few as one and as many as desired.

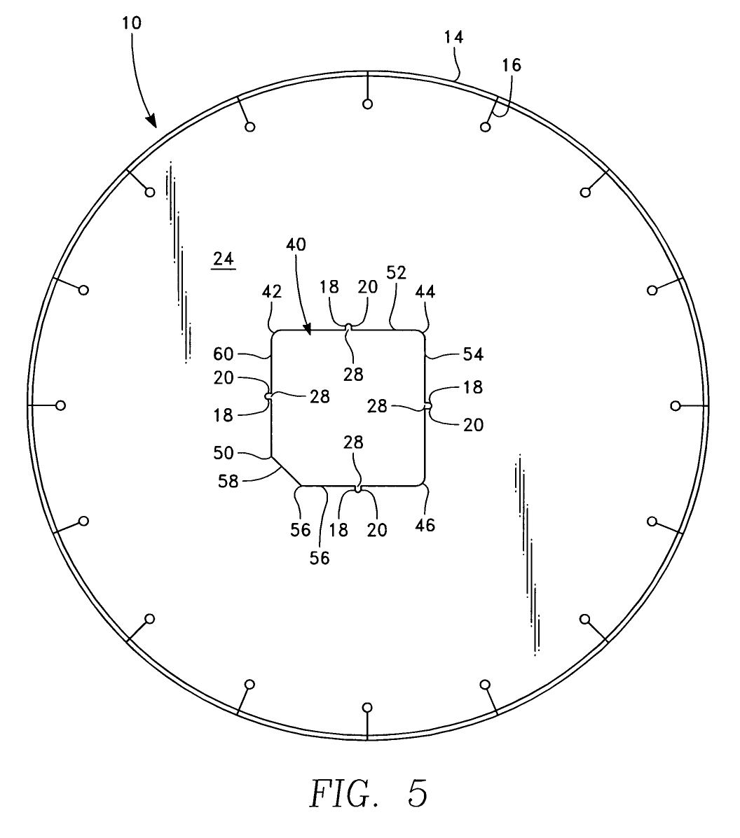

When the core is to be used with certain arbors, the cut-out of the “square” 40 is easily achieved through force. Once the “square” 40 is punched out (FIG. 5), the core is ready to receive arbors that are of unconventional shape that will fit therein.

The discussion included in this patent is intended to serve as a basic description. The reader should be aware that the specific discussion may not explicitly describe all embodiments possible and alternatives that are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

What is claimed is:

1. A cutting disc core for a circular saw blade comprising:
a circular shaped body having a center hole of a certain size and a continuous peripheral edge, said peripheral edge adapted to having cutting segments mounted thereon;
a lasered shape that surrounds said center hole, said lasered shape further comprising
a first side;
a second side connected substantially perpendicularly to said first side;
a third side connected substantially perpendicularly to said second side;
a fourth side connected to said third side at an angle greater than 90 degrees;
a fifth side connected to said fourth side at an angle greater than 90 degrees and connected substantially perpendicularly to said first side;
one or more pairs of radially extending members that extend radially from one of said sides of said lasered shape wherein in combination said one or more pairs of radially extending members defines a tab that can be punched out with force thereby allowing the center of said disc core to no longer define a center hole, but rather to define an empty space of the same shape as said lasered shape for use with arbors of unique shape.

2. The cutting disc core as defined in claim 1 wherein the junction of said first side and said second side is a rounded corner.

3. The cutting disc core as defined in claim 1 wherein the junction of said second side and said third side is a rounded corner.

4. The cutting disc core as defined in claim 1 wherein the junction of said third side and said fourth side is a sharp corner.

5. The cutting disc core as defined in claim 1 wherein the junction of said fourth side and said fifth side is a sharp corner.

6. The cutting disco core as defined in claim 1 wherein the junction of said fifth side and said first side is a rounded corner.
